(19) United States
(12) Patent Application Publication
(10) Pub. No.: US 2014/0215830 A1
(43) Pub. Date: Aug. 7, 2014

(54) Tool for slitting jacket of eletrical cable

(71) Applicant: SEATEK CO. INC., Stamford, CT (US)

(72) Inventor: Lucien Ducret, Stamford, CT (US)

(73) Assignee: Seatek Co. Inc., Stamford, CT (US)

(21) Appl. No.: 13/815,115

(22) Filed: Feb. 1, 2013

(51) Int. Cl. H02G 1/12

(52) U.S. Cl. CPC H02G 1/1217
USPC 30/90.9; 30/90.8

(57) ABSTRACT

A cable cutting tool for producing slits in medium and large-diameter cable in a safe and efficient manner includes a cable supporting component and a blade supporting component. The supporting components are displaceable relative to one another to provide an opening corresponding to the cable of the desired diameter. The blade supporting component includes a cartridge and two blades mounted to the cartridge. The blades are uniformly configured to provide a two slit cut defining a rectangular strip along the jacket of the cable which can be easily removed from the cable.

### BACKGROUND OF THE DISCLOSURE

1. Field of the Disclosure

The disclosure relates to the art of cable processing tools. More particular, the disclosure relates to a safe cutting tool for producing slits in medium and large-diameter cable in a safe and efficient manner.

2. Prior Art Discussion

The manufacturing process of electrical cable is completed when the integrity, i.e., continuity of a cable is verified. Typically, medium-to-large diameter cables are spooled on rigs. To conduct the test, a free end of the cable is stripped.

Typical cutting tools used for stripping of the cable's jacket include exacto or utility knives configured with an unprotected blade. Recent safety regulations have been enacted to dissuade the use of these tools to reduce knife-related injuries.

The safety issue was addressed by by a blade assembly disclosed in U.S. Pat. No. 5,337,479 commonly owned with the present application and fully incorporated herein by reference. The disclosed blade assembly is configured to prevent contact between the operator and blade. However, as practice shows, while the blade assembly certainly meets safety requirements, the cuts produced by this assembly may be somewhat improved for the following reasons.

The majority of electrical cables are fabricated by extruding a jacket over the conductor's core. During this process the core and jacket are bonded to one another. Before cables are connected, the jacket, which is made from thick and tough plastics or rubberized resin, should be removed. However, this task, as one of ordinary skill in the art knows, is time and effort consuming.

As a thin sharp blade cuts an elongated slit through the jacket along the cable's longitudinal axis or produces a circular cut, the material tends to close up behind the blade. To find the slit after cutting is very difficult. When detected, the jacket is difficult to peel off by commonly used pliers.

Therefore, another need exists for a new cutting tool facilitating the removal of a jacket off the cable.

The tool designers often try to configure tools capable of performing either multiple tasks or the same task for differently dimensioned objects. Typically, any manufacturing industry deals with a great variety of differently dimensioned cables. However, the adjustment of the same cutting tool for performing the same cutting operation for variously dimensioned cables is either impossible, necessitating the use of multiple tools, or complicated.

A further need therefore exists for a cutting tool provided with a guide mechanism which is configured to adjust the tool quickly and to operate in an efficient manner with variously dimensioned cables.

### SUMMARY OF THE DISCLOSURE

The above-discussed needs are satisfied by the present disclosure. The disclosed tool for slitting the cable's jacket is configured with an elongated supporting component which is structured to support a cable that may have various diameters. A further component of the tool is configured to bear a blade assembly and pivotally mounted on the cable supporting component to swing between a rest position and a cutting position in which the cable and blade supporting components extend in parallel planes. The tool is further structured with a guide mechanism coupled to the cable and blade supporting components, respectively, and operable to provide displacement between these components to accommodate cables of different outer diameters.

In accordance with one aspect of the disclosure, the blade assembly is mounted to the blade supporting component and includes multiple uniformly configured blades. The blades are spaced apart and straddle the longitudinal axis of the cable supporting component. As the blades simultaneously cut the jacket, two slits define a strip in the jacket which is easily detected and removed.

In accordance with a further aspect, the guide mechanism is configured with two spaced parallel arms displaceably fixed to the blade supporting component. One of the plates is configured to provide an incremental enlargement of the opening between the blade- and cable-supporting components which corresponds to the desired cable diameter. The other plate is slotted to guide the cable- and blade supporting components relative to one another along the desired linear path while the adjustment of the opening between these parts continues.

### BRIEF DESCRIPTION OF THE DRAWINGS

The above and other features and advantages of the disclosed structure will become more readily apparent from the following specific description accompanied by the drawings, in which:

FIG. 1 is a perspective view of the disclosed tool in the assembled state;

FIGS. 1A and 1B are elevated front views illustrating cutting cables of relatively small and relatively large diameters, respectively;

FIG. 2 is an exploded view of the disclosed tool;

FIG. 3 is an elevated side view of the disclosed tool in the operating position;

FIG. 4 is a bottom view of the disclosed device;

FIG. 5 is an elevated cross-section side view of the blade supporting component of the disclosed tool; and

FIG. 6 is a perspective view of another embodiment of the disclosed tool configured to produce a circular cut with the inventive blade assembly.

### SPECIFIC DESCRIPTION

Reference will now be made in detail to the preferred embodiments of the disclosure. Wherever possible, same or similar reference numerals are used in the drawings and the description to refer to the same or like parts or steps. The drawings are in very simplified form and are not to precise scale.

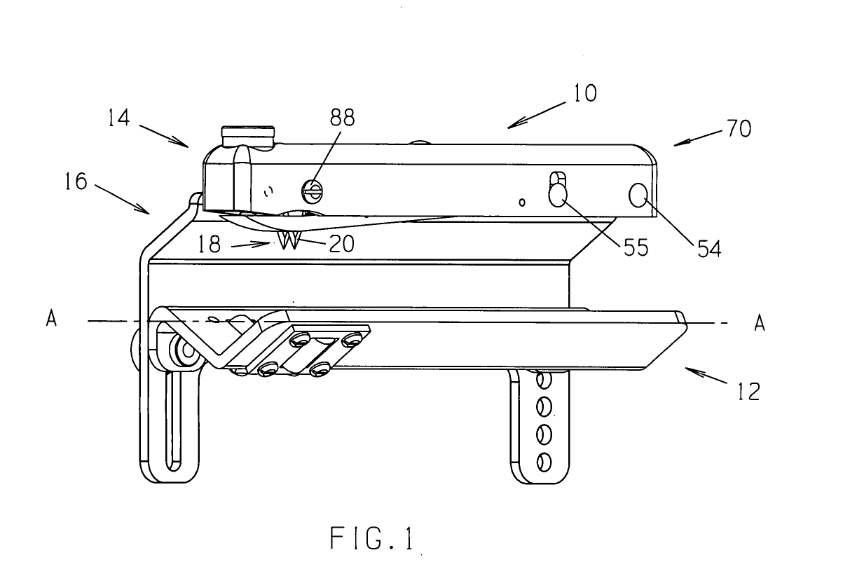

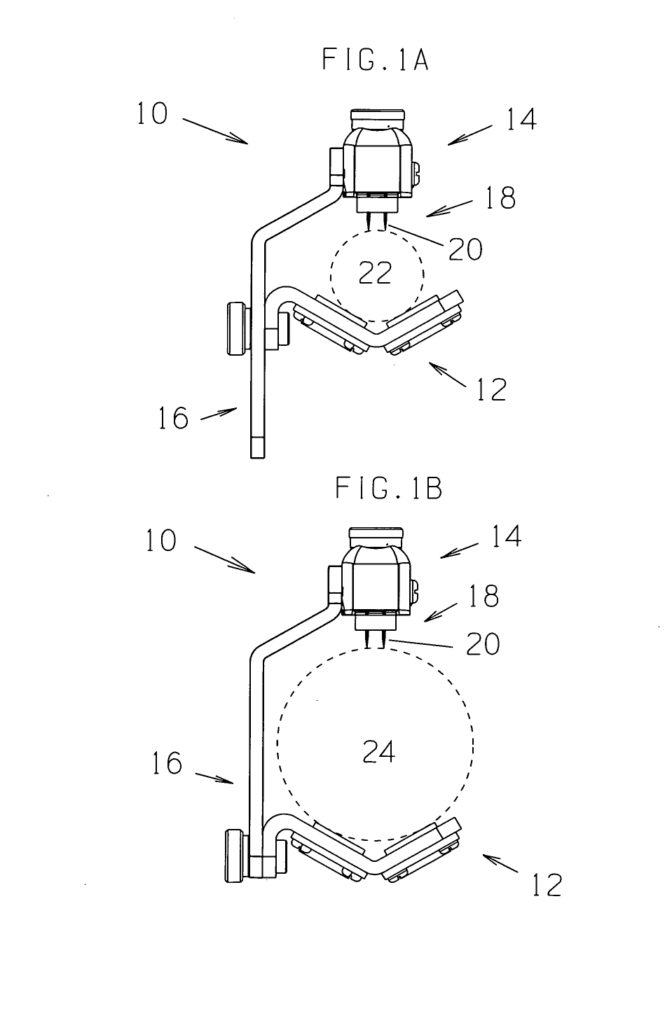

Referring to FIGS. 1, 1A and 1B, a tool 10 includes a cable supporting component 12, a blade supporting component 14 and a guide mechanism 16. The tool 10 is configured to produce longitudinal cuts by a blade assembly 18 which includes two uniformly configured blades 20. Displacing the tool and cable relative to one another, blades 20 cut two parallel slits in the jacket which define there in between a rectangular strip. The strip can be easily picked up and peeled off by any suitable means, such as pliers or even manually. The tool 10 is adjusted to cut small and large diameter cables 22 and 24, as illustrated in respective FIGS. 1A and 1B and explained in detail below.

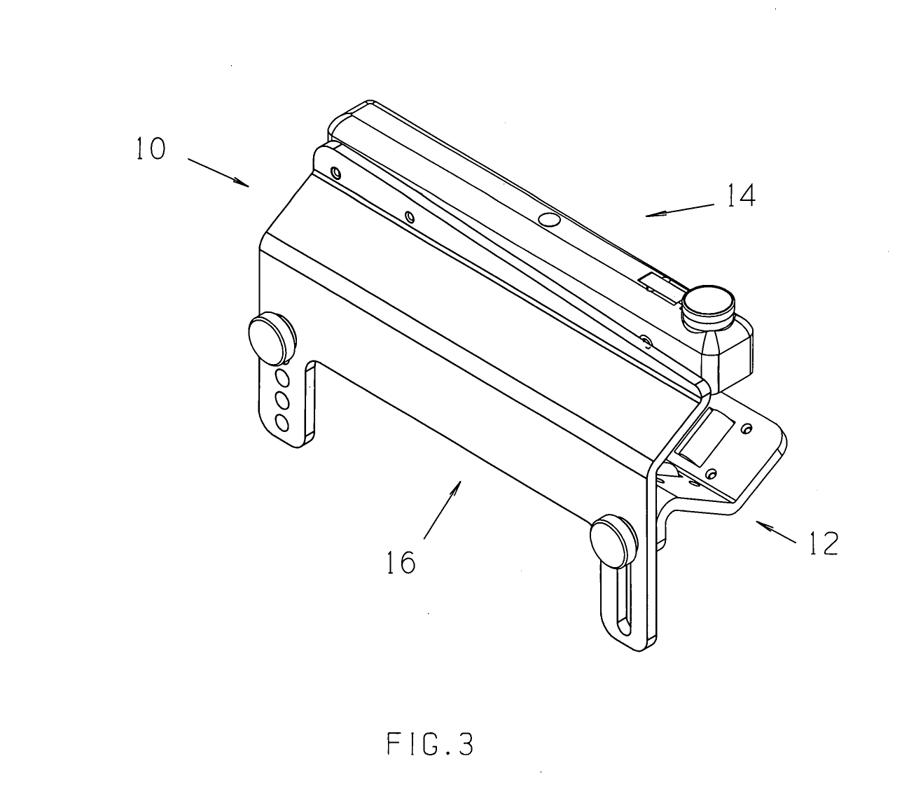

In operation, cable 22/24 is placed on cable support 12 whose position relative to blade supporting component 14 is adjusted by manipulating guide mechanism 14. The blade supporting component 14, which is swung outwards in the starting position, pivots back to its working position, in which cable and blade supporting components are substantially parallel to one another as better shown in FIG. 3, with the blades set for the desired cable diameter engaging the cable's jacket. Thereafter, the cable and tool 10 are displaced in opposite axial directions in response to an external force applied by the operator. As a result, a strip is provided on the jacket which then can be peeled off exposing the cable's conductors.

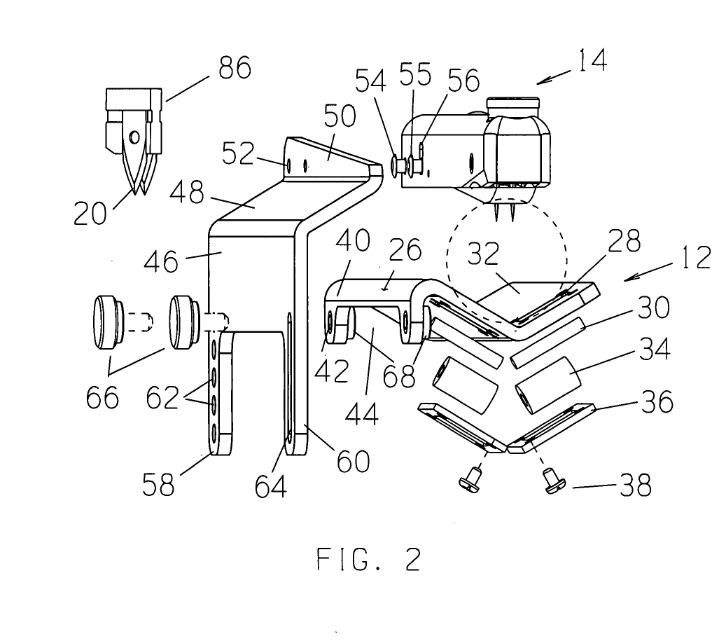

Referring to FIGS. 1 and 2, cable supporting component 12 includes a support 26 configured with a V-shaped bed 28 which receive the cable. Displacement of the cable relative to bed 28 is facilitated by two roller guides allowing the cable to slide relative to the support along its longitudinal axis A-A. The roller guides each are structured with a shaft 30 traversing a roller 34 which extends through the recess in a web 32 of bed 28 slightly above the plane of web 32 and holding the ends of shafts 30. The shaft retainer 36, configured as a recessed plate, attaches the roller/shaft combination to support 26 by means of a shaft retainer screw 38.

The cable supporting component 12 is further configured with a flange 40 extending from one of webs 32 of bed 28 towards the bed's bottom in a plane generally perpendicular to axis A-A. The flange 40 may be a one-piece structure or, as shown in FIG. 2, may have multiple, spaced apart legs 42 each provided with an opening 44 for further coupling of support component 12 to the rest of the tool, as explained below.

The guide mechanism 16 includes a Z-shaped body having preferably, but not necessarily, a unitary structure configured with three plate-like elements 46, 48 and 50, respectively. Two plates 46 and 50, respectively, extend in substantially parallel planes, while element 48 bridges the former two plates. The upper plate-like element or shoulder 50 may have a variety of cross-sections and, as shown, is configured with a generally triangular cross-sectional shape. Provided with two opening 52, element 50 is detachably fastened to blade supporting component 14 by a shoulder rivet pivot 54 traversing shell 70. The relative position between blade supporting component 14 and guide mechanism 16 can be controlled by their relative displacement which leads to changing the position of rivet 55 along respective elongated slots 56 made in blade supporting component 14.

The plate component 46 of guide mechanism 16 is recessed to have two arms 58 and 60, respectively. The leg 58 is slotted to have a plurality of holes 62, whereas leg 60 includes a single elongated slot 64. The holes 62 are arranged to incrementally adjust a position of components 12 and 14, respectively, to accept cables of different diameters. As a thumb screw 66 traverses the desired hole 62, it is received in a press fit threaded bushing 68 formed in one of legs 42 of flange 40 of V-shaped support 26. The other thumb screw 66 is slidably guided along slot 64 and, as the desired position is set, it is fixed in another threaded bushing 68 provided in second leg 42.

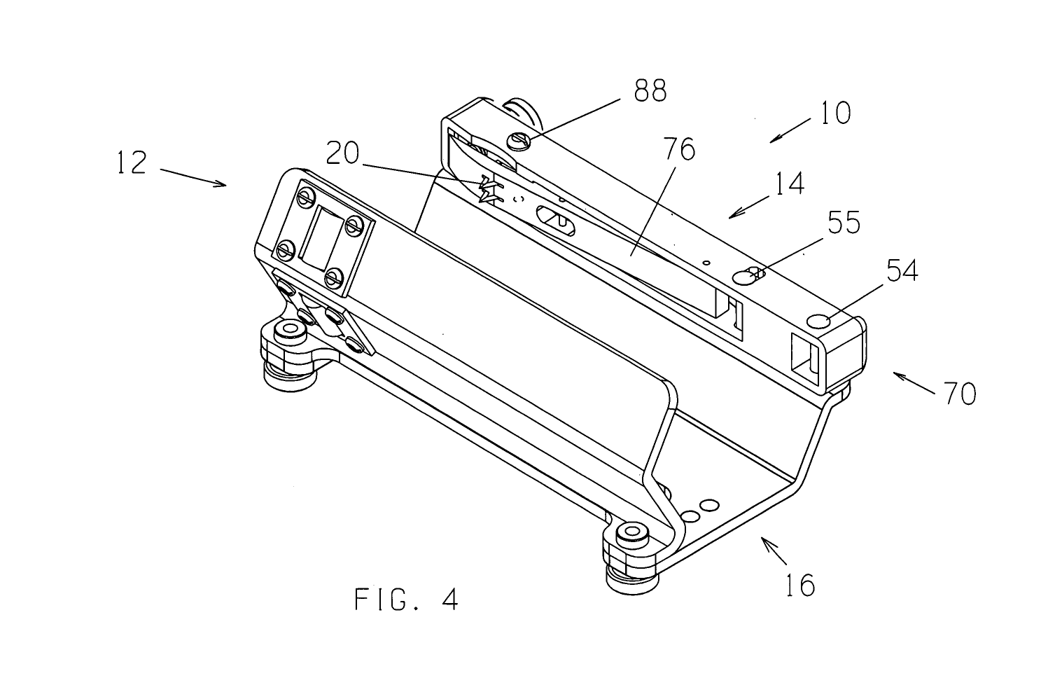

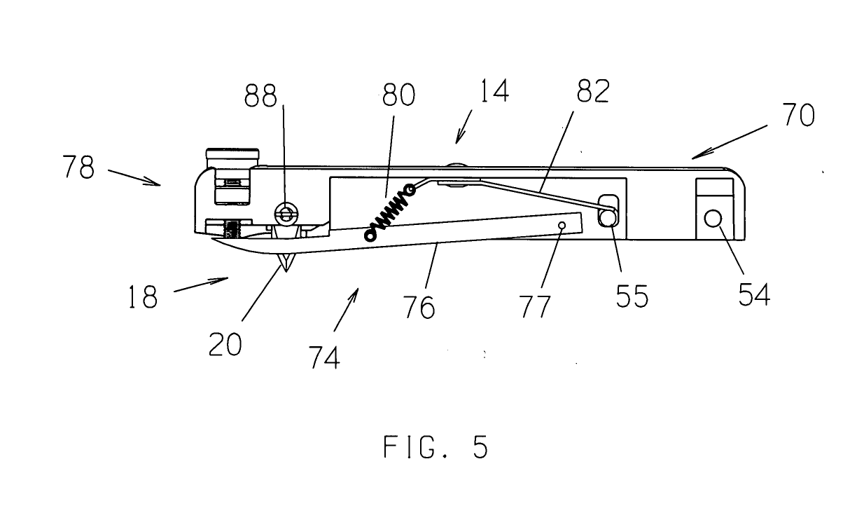

Referring to FIGS. 2 and 4 and 5, blade supporting component 14 includes a shell 70 opening towards cable supporting component 12 in the assembled state of tool 10. When blade supporting component 14 is mounted to guide mechanism 16, components 12 and 14 are operatively coupled to one another so that shell 70 pivots about a rear shoulder rivets 54 between open and working position. A spring mechanism 74 FIG. 5 includes a solid pivoting shoe 76 over pin 77 and having a passage which cooperates with twin blades 20 so that the latter can penetrate through the shoe at the desired depth after the latter is adjusted by means of a blade adjusting mechanism 78. The spring mechanism 74 further includes a spring assembly including a extension spring 80 coupled by one of its ends to the mid-region of the solid shoe 76 and by the opposite end to shell 70. Attached to the other end of extension spring 80 is a leaf spring 82 which has the opposite end therefore braced against a shoulder rivet shank 54. Blade assembly 20 includes a cartridge 86 FIG. 2 with blades 20 encased within the cartridge 86. Returning to FIG. 5 the cartridge 86 is held is to shell 70 by screw 88.

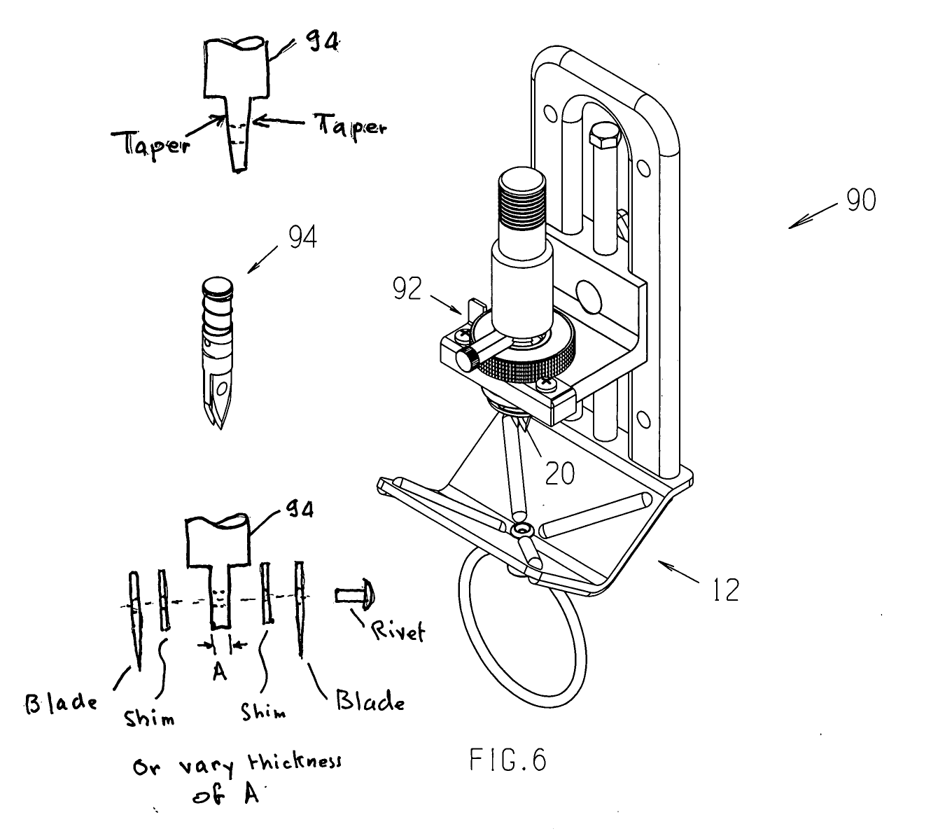

Turning to FIG. 6, a twin blade assembly 94 may be used for producing a ring cut. The tool 90 is disclosed in detail in U.S. patent application Ser. No. 13/136,928 fully incorporated herein by reference. In this embodiment, v-shaped cable supporting component 12 receives the cable and, after the blade penetration depth is adjusted by a mechanism 92, the tool and cable are rotated relative to one another. During the rotation, twin blades 20 produce a rectangular ring strip in a plane perpendicular to the longitudinal axis of the cable to be cut.

Having described some of the preferred embodiments of the present invention with reference to the accompanying drawings, it is to be understood that the invention is not limited to those precise embodiments and parameters. The configuration of the entire system is not limited to that shown and discussed above. Thus various changes, modifications, and adaptations may be effected therein by one skilled in the art without departing from the scope or spirit of the invention as disclosed above and claimed below.

1. A tool for slitting a jacket of a cable, comprising:
a cable supporting component extending along a longitudinal axis;
a blade supporting component pivotal about a pivot axis, which extends perpendicular to the longitudinal axis, between a rest position and a cutting position in which the cable and blade supporting components extend in parallel planes;
a guide mechanism coupled to the cable and blade supporting components and operable to provide displacement between the supporting components to accommodate cables of different outer diameters; and
a blade assembly mounted to the blade supporting component and including two uniformly configured blades which are spaced apart and straddling the longitudinal axis, the blades cutting the jacket to create a rectangular groove defining a strip in the jacket upon longitudinal displacement of the cable and blade assembly relative to one another in the cutting position of the blade supporting component.

2. The tool of claim 1, wherein the cable supporting component is configured with a U- or V-shaped unitary base having two longitudinal sections which extend at angle towards one another and spaced from the blade supporting mechanism to receive the cable.

3. The tool of claim 2 further comprising a plurality of rollers mounted rotatably to respective sections of the unitary base about respective parallel rotation axes extending perpendicular to the longitudinal axis and operative to provide displacement of the cable relative to the cable and blade supporting components along the longitudinal axis in response to an applied linear force.

4. The tool of claim 3 further comprising a plurality of shafts each extending through the roller and mounted to the section of the base, and a U-shaped retaining plate coupled to the base to support the shafts.

5. The tool of claim 2, wherein one of the sections of the base is configured with a flange extending in a plane perpendicular to the longitudinal axis and provided with one or plurality of through-going openings, the flange being slidably coupled to the guide mechanism.

6. The tool of claim 5, wherein the guide mechanism is configured with opposite two parallel terminal plates, which are spaced from one another and extend parallel to the flange of the base upon coupling the flange to the guide mechanism, and an intermediary plate bridging the terminal parts, one of the terminal plates being removably fixed to the blade supporting components.

7. The tool of claim 6, wherein another terminal plate is configured with a plurality of spaced longitudinal arms extending in the plane perpendicular to the longitudinal axis, one of the arms being provided with a continuous longitudinal channel and at least one another arm including a row of holes which are spaced from one another in the plane perpendicular to the longitudinal axis.

8. The tool of claim 7 further comprising a plurality of thumb screws traversing respective through-going holes of the flange of the base and guide channels of the respective arms upon displacing the base and guiding mechanism relative to one another to a position corresponding to the outer diameter of the cable to be slit.

9. The tool of claim 8 further comprising a plurality of press-fit nuts each coupled to the thumb screw in the desired position.

10. The tool of claim 6, wherein the blade supporting component is configured with a housing and a cartridge removably supporting the blades.

11. A cutting tool for removing a jacket from electrical cable, comprising:
A cable receiving component;
A blade supporting component operatively coupled to the cable receiving component and comprising a blade assembly configured with a cartridge and a pair of blades mounted to the cartridge.
